(19) United States
(12) Patent Application Publication
(10) Pub. No.: US 2015/0266752 A1
(43) Pub. Date: Sep. 24, 2015

(54) IODINE ADSORBENT, WATER TREATING TANK AND IODINE ADSORBING SYSTEM

(71) Applicant: KABUSHIKI KAISHA TOSHIBA, Tokyo (JP)

(72) Inventors: YUMIKO SEKIGUCHI, KAWASAKI (JP); TOMOHITO IDE, TOKYO (JP); ARISA YAMADA, KAWASAKI (JP); TOSHIHIRO IMADA, KAWASAKI (JP)

(21) Appl. No.: 14/632,424

(22) Filed: Feb. 26, 2015

(30) Foreign Application Priority Data
Mar. 18, 2014 (JP) 2014-055608

(51) Int. Cl. C02F 1/28; C07F 7/18

(52) U.S. Cl. CPC C02F 1/288; C07F 7/1804; C02F 1/281; C02F 1/285; C02F 2101/12

(57) ABSTRACT

An iodine adsorbent includes a carrier that is a compound containing silicon, an organic group bonded to the carrier, and silver. The organic group has, at the terminal, a functional group represented by S⁻ or SR. The silver is bonded to sulfur in S⁻ or SR. The R is a hydrogen atom or a substituent containing a hydrocarbon. Where the element ratio of sulfur in the adsorbent to silicon in the adsorbent is M_{S}/M_{Si}, M_{S}/(M_{Si}·A), a value obtained by dividing the element ratio by a specific surface area A (m²/g) of the carrier, is 2.4×10⁻⁴ g/m²≦M_{S}/(M_{Si}·A)≦2.7×10⁻⁴ g/m².

### CROSS-REFERENCE TO RELATED APPLICATION

This application is based upon and claims the benefit of priority from Japanese Patent Application No. 2014-055608 Mar. 18, 2014; the entire contents of which are incorporated herein by reference.

### FIELD

Embodiments described herein relate to an iodine adsorbent, a water treating tank and an iodine adsorbing system.

### BACKGROUND

Effective utilization of water resources is desired in view of development of industries and growth of population. To this end, recycle of wastewater is very important. For achieving recycle of wastewater, purification of water, i.e. separation of other substances from water is necessary. Various kinds of methods for separating other substances from a liquid are known, and examples thereof include membrane separation, centrifugal separation, activated carbon adsorption, ozone treatment, and removal of suspended substances by coagulation. The above-mentioned methods can be used to remove chemicals contained in water and having significant influences on the environment, such as iodine and nitrogen, or to remove oils and clay dispersed in water.

Iodine is an element which plays an important role in various fields such as fields of pharmaceutical products such as X-ray contrast agents and labeling reagents for image diagnosis; fields of optical articles such as lasers and polarizing plates for LCD; and fields of electronic materials such as organic conductors and dye-sensitized solar cells. Thus, due to expansion of demand for iodine and tightening of environmental regulations in recent years, collection/recycle of iodine has become increasingly important.

For selectively collecting iodine, activated carbon and silica gel each loaded with silver are commercially available. These materials take advantage of high bonding strength between silver and iodine. In these materials, however, in view of their production process, silver is considered to be deposited only in the form of a salt on activated carbon or silica gel, so that the carried amount of silver is small, and when these materials are used in water, performance may be deteriorated due to elution of silver.

Since silica gel is dissolved in water and a water-soluble organic solvent, use of silica gel as a support may cause deterioration of system performance due to a change in space speed as the volume of an adsorbent decreases, and the shrunk adsorbent passes through a filter to flow out to the outside of the operating environment in the case where the adsorbent is used in an aqueous medium for a long period of time.

### BRIEF DESCRIPTION OF THE DRAWINGS

FIG. 1 is a conceptual view of a water treating system using an iodine adsorbent of an embodiment;

FIG. 2 is a sectional schematic view of a water treating tank connected to a pipe;

FIG. 3 is a solid C13 NMR spectrum in examples;

FIG. 4 is a graph showing a dependency of the iodine adsorption amount on time in examples; and

FIG. 5 is a graph showing a dependency of the iodine adsorption amount on time in examples;

### DETAILED DESCRIPTION

An iodine adsorbent of an embodiment includes a carrier that is a compound containing silicon, an organic group bonded to the carrier, and silver. The organic group has, at the terminal, a functional group represented by S⁻ or SR. The silver is bonded to sulfur in S⁻ or SR. The R is a hydrogen atom or a substituent containing a hydrocarbon. Where the element ratio of sulfur in the adsorbent to silicon in the adsorbent is M_{S}/M_{Si}, M_{S}/(M_{Si}·A), a value obtained by dividing the element ratio by a specific surface area A (m²/g) of the carrier, is 2.4×10⁻⁴ g/m²≦M_{S}/(M_{Si}·A)≦2.7×10⁻⁴ g/m².

A water treatment tank of an embodiment stores an iodine adsorbent of an embodiment.

An iodine adsorbing system of an embodiment includes an adsorbent unit having an iodine adsorbent of an embodiment, a supplying unit supplying target medium water including iodide, to the adsorbent unit, a discharging unit discharging the target medium water from the adsorbent unit, a measuring unit measuring concentration of an iodide in the target medium water provided in a supplying unit side, a discharging unit side, or both of the supplying unit side and the discharging unit side, and a controller controlling flow of the target medium water from the supplying unit to the adsorbent unit when a value calculated or obtained from a measured value in the measuring unit reaches set value.

A method for producing an iodine adsorbent of an embodiment includes subjecting a carrier, which is a compound having a water content u of 10% by mass≦u≦30% by mass and containing silicon, to a coupling reaction with a coupling agent containing an organic group having at a terminal a functional group represented by S⁻ or SR, and bringing a reaction product. The reaction product is obtained by the coupling reaction, into contact with an organic acid or inorganic acid containing silver. The water content u of the carrier before the coupling reaction is preferably 20% by mass≦u≦30% by mass.

(Iodine Adsorbent)

An iodine adsorbent of an embodiment includes a carrier, an organic group having, at the terminal, a functional group bonded to the carrier and represented by S⁻ or SR, and silver bonded to sulfur in S⁻ or SR. R is a hydrogen atom or a substituent containing a hydrocarbon. Where the element ratio of sulfur in the adsorbent to silicon in the adsorbent is M_{S}/M_{Si}, M_{S}/(M_{Si}·A), a value obtained by dividing the element ratio by a specific surface area A (m²/g) of the carrier, is preferably not less than 2.4×10⁻⁴ g/m² and not more than 2.7×10⁻⁴ g/m² (2.4×10⁻⁴ g/m²≦M_{S}/(M_{Si}·A)≦2.7×10⁻⁴ g/m²).

The carrier of the embodiment is preferably a member capable of imparting to the iodine adsorbent a strength enabling the iodine adsorbent to be put to a practical use. The carrier for introducing an organic group is preferably one having many hydroxyl groups on the surface, so that the modification ratio of the carrier is increased through the production method described below. For the carrier, an acidic carrier, a neutral carrier obtained by subjecting an acidic carrier to a neutralization treatment beforehand, or the like may be used. The neutralization treatment includes, for example, treating a carrier in an additive such as calcium ions. As the carrier, specifically a compound containing silicon of at least one of silica gel (SiO₂, neutral, acidic), alminosilicate and silica alumina can be used.

Even a metal oxide can be used alone similarly to the silica gel. Examples of the metal oxide may include alkoxides and halides that form titania (TiO₂), alumina (Al₂O₃), zirconia (ZrO₂), cobalt trioxide (CoO₃), cobalt oxide (CoO), tungsten oxide (WO₃), molybdenum oxide (MoO₃), indium tin oxide (ITO), indium oxide (In₂O₃), lead oxide (PbO₂), lead zirconate titanate (PZT), niobium oxide (Nb₂O₅), thorium oxide (ThO₂), tantalum oxide (Ta₂O₅), calcium titanate (CaTiO₃), lanthanum cobaltate (LaCoO₃), rhenium trioxide (ReO₃), chromium oxide (Cr₂O₃), iron oxide (Fe₂O₃), lanthanum chromate (LaCrO₃) and barium titanate (BaTiO₃) and so on.

The size of the carrier in this embodiment is preferably not less than 100 μm and not more than 5 mm (100 μm≦d≦5 mm) in terms of an average particle size d. When the average particle size of the carrier is not less than 100 μm and not more than 5 mm (100 μm≦d≦5 mm), for example, both the level of filling ratio of the iodine adsorbent in a column, a cartridge or a tank and the ease of water conduction can be made satisfactory at the time of performing adsorption of iodine. When the average particle size is less than 100 μm, the filling ratio of the iodine adsorbent in the column or the like becomes excessively high to reduce the ratio of voids, so that it is difficult to perform water conduction. On the other hand, when the average particle size is more than 5 mm, the filling ratio of the iodine adsorbent in the column or the like becomes excessively low to increase voids, so that although water conduction is easily performed, a contact area between the iodine adsorbent and wastewater containing iodine decreases, resulting in a reduction in adsorption ratio of iodine by the iodine adsorbent. The average primary particle size of the carrier d is preferably not less than 100 μm and not more than 2 mm (100 μm≦d≦2 mm), further preferably not less than 300 μm and not more than 1 mm (300 μm≦d≦1 mm).

The average particle size can be measured by a screening method. Specifically, the average primary particle size can be measured by screening particles using a plurality of sieves with apertures ranging from 100 μm to 5 mm in accordance with JIS Z8901: 2006 “Test Powders and Test Particles”.

In the iodine adsorbent of this embodiment, the size of the adsorbent itself can be adjusted only by changing the size of the carrier, and for obtaining an adsorbent that is easily handled, the size of the carrier may be set to a predetermined size. That is, an iodine adsorbent that is easily handled can be obtained without performing operations such as granulation. Since it is not necessary to perform granulation etc., a production process required to obtain an iodine adsorbent that is easily handled can be simplified, so that costs can be reduced.

The organic group in the embodiment has, at the terminal, a functional group bonded to the carrier and represented by S or SR. S⁻ means a thiolate part. SR at the terminal means a functional group such as a thiol group, a sulfide group or a thioester polyol group. When R in SR is large in a functional group, coordination of a metal or a metal ion and adsorption of iodine may be hindered by steric hindrance. Thus, the carbon number of R as a substituent is preferably 6 or less. When a coupling agent having the above-mentioned functional group is reacted with the carrier, organic groups are introduced into the carrier. Examples of the coupling agent include silane coupling agents, titanate-based coupling agents and aluminate-based coupling agents. When organic groups are introduced with a coupling agent, oxygen bonded to the carrier and sulfur at the terminal are bonded to each other preferably by a carbon chain with a carbon number of 1 to 6. Oxygen bonded to the carrier and sulfur at the terminal are bonded to each other more preferably by a linear carbon chain with a carbon number of 1 to 6. Examples of the organic group having a carbon chain with a carbon number of 1 to 6 include organic groups having an alkyl chain or an alkoxy chain. The organic group having an alkyl chain or an alkoxy chain may have a side chain.

Silver is bonded to sulfur in the embodiment to function as an iodine adsorbent. When silver is in the form of an ion, a monovalent silver ion is preferred. The iodine adsorbent may contain zero-valent silver. When silver is zero-valent silver, the zero-valent silver is, for example, one with a silver ion reduced by sulfur in the organic group. Silver ions may form an ionic bond with their counter anions.

M_{S}/M_{Si}(−), an atomic ratio of sulfur of organic groups to silicon of the whole adsorbent in the embodiment, can be measured by scanning electron microscope energy dispersive X-ray spectroscopy (SEM-EDX: Scanning Electron Microscope-Energy Dispersive X-ray Spectroscopy).

The SEM-EDX measurement method is carried out under the following conditions. The measurement range is the whole of a visual field observed with a magnification of 10,000.
Sample preparation: a sample is dispersed on a carbon tape in an appropriate amount, and carbon-deposited.
Device: ULTRA55 (SEM) manufactured by Carl ZEISS; NSS312E(EDX) manufactured by Thermo Fisher.
Electron beam condition (accelerating voltage): 6 kV.
Observation magnification: 10000.
Observation mode: reflected electron image.

In the embodiment, M_{S}/(M_{Si}·A) (g/m²), a value obtained by dividing M_{S}/M_{Si} (−) by a specific surface area A (m²/g) of the carrier, is preferably not less than 2.4×10⁻⁴ (g/m²) and not more than 2.7×10⁻⁴ (g/m²) (2.4×10⁻⁴ g/m²≦M_{S}/(M_{Si}·A)≦2.7×10⁻⁴ g/m²) from the viewpoint of iodine adsorbing performance and suppression of elution of a carrier. When M_{S}/(M_{Si}·A) (g/m²) is less than 2.4×10−⁻⁴ (g/m²), the coverage of the surface of the adsorbent is low, and therefore there are a large amount of silanol (SiOH) groups exposed at the surface, resulting in an increase in eluted amount of silica gel that is a carrier (because elution of silica gel starts with a silanol group as a starting point). On the other hand, when M_{S}/(M_{Si}·A) (g/m²) is more than 2.7×10⁻⁴ (g/m²) the surface coverage is high, and therefore pores are partially closed to reduce water permeability, so that the interior of the adsorbent cannot be used, or hydrophobicity of the surface is enhanced to reduce hydrophilicity of the adsorbent, leading to deterioration of the adsorbing capability.

Anions as counter ions of silver ions are organic acid ions or inorganic acid ions. Examples of organic acid ions as counter ions of silver ions include acetate ions, lactate ions, citrate ions and salicylate ions. Examples of inorganic acid ions as counter ions of silver ions include nitrate ions, sulfate ions, carbonate ions, chlorate ions, nitrite ions, perchlorate ions and sulfite ions. These anions may be contained in the iodine adsorbent.

It is considered that in the iodine adsorbent in the embodiment, silver bonded to sulfur in a functional group contained in an organic group of the iodine adsorbent and represented by S⁻ or SR adsorbs iodine contained in target water. That is, in the target water, iodine exists in the form of anions such as an iodide ion (I⁻) or an iodate ion (IO₃⁻), and the anion may be bonded to silver to adsorb iodine in the target water.

(Method for Producing Iodine Adsorbent)

A method for producing the iodine adsorbent of this embodiment will now be described. However, the production method described below is one example, and the method is not particularly limited as long as the iodine adsorbent of this embodiment is obtained. It is preferred that after each treatment is performed, filtration, washing with an appropriate solvent such as a reaction solvent, toluene, pure water or an alcohol, and drying are performed, followed by performing the next treatment. The method for producing an iodine adsorbent according to an embodiment includes subjecting a carrier, which is a compound having a water content u of not less than 10% by mass and not more than 30% by mass (10% by mass≦u≦30% by mass) and containing silicon, to a coupling reaction with a coupling agent containing an organic group having at a terminal a functional group represented by S⁻ or SR; and bringing a reaction product, which is obtained by the coupling reaction, into contact with an organic acid or inorganic acid containing silver.

First, the above-described carrier is provided, and the surface of the carrier is treated with a coupling agent, which has, at the terminal, a functional group represented by S⁻ or SR, to introduce a thiol part, a sulfide part or the like into the carrier. The carrier is preferably one subjected to a wet treatment as a pretreatment before the reaction with a coupling agent. The water content of the carrier is preferably not less than 10% by mass and not more than 35% by mass (10% by mass≦u≦35% by mass). The water content of the carrier is more preferably not less than 10% by mass and not more than 30% by mass (10% by mass≦u≦30% by mass). The water content of the carrier is furthermore preferably not less than 20% by mass and not more than 30% by mass (20% by mass≦u≦30% by mass). Examples of the coupling agent include thiol-based coupling agents such as γ-sulfanylpropyltrimethoxysilane, γ-sulfanylpropyltriethoxysilane, 3-mercaptopropyltrimethoxysilane, 3-mercaptopropyltriethoxysilane and 3-mercaptopropylmethyldimethoxysilane; sulfide-based coupling agents such as bis(triethoxysilylpropyl)tetrasulfide; and coupling agents such as sulfanyl titanate, sulfanyl aluminum chelate and sulfanyl zircoaluminate.

The reaction of the coupling agent with the carrier is carried out by a method in which the coupling agent is vaporized and reacted with the carrier; a method in which the coupling agent is mixed in a solvent, and the mixture is mixed with the carrier to carry out a reaction; or a method in which a solvent is not used, and the coupling agent is brought into direct contact with the carrier to carry out a reaction. The amount (ratio) of sulfur introduced into the iodine adsorbent can be adjusted by performing heating or decompression when the coupling agent and the carrier are reacted.

The reaction solvent may be one that can dissolve a coupling agent having a thiol part and a thiolate part, such as an alcohol and a mixed solvent of an alcohol and water although an aromatic solvent is more preferred. Regarding the reaction temperature, particularly use of an aromatic solvent is preferred because the coupling agent is hardly hydrolyzed, and a condensation reaction between coupling agents hardly occurs. Further, use of an aromatic solvent is preferred because a treatment can be performed at a high temperature, so that the modification ratio of ligands can be increased. On the other hand, in a water-soluble solvent, it is preferred that the reaction is carried out at a lower temperature because the coupling agent is easily hydrolyzed then a condensation reaction between coupling agents also easily occurs.

For example, a carrier into which organic groups are introduced through a coupling reaction may be used directly in a reaction for carrying silver after the carrier is washed and dried, or may be heated in an alcoholic solvent containing a glucono-1,5-lactone before silver is carried. For washing and drying, for example, it is preferred that the carrier is washed with a solvent for the organic group introduction reaction, and then dried by air at a normal temperature (25° C.) or dried by hot air. The temperature for drying by hot air is not particularly limited as long as it is a temperature at which the carrier is dried, but for example, a temperature of 200° C. or lower is preferred. As the alcoholic solvent, methanol, ethanol, propanol, butanol or the like can be used. An organic solvent such as acetone, THF, DMSO or DMF can be used depending on a carrier and an organic group. The heating temperature is preferably not lower than room temperature (25° C.) and not higher than a boiling point although the preferred range varies depending on a solvent. Although the principle of this treatment is not clarified yet, the iodine absorbing capability of the iodine adsorbent is improved. It is preferred that even after the heating treatment in the alcoholic solvent, the carrier is washed with an alcoholic solvent and pure water, and further subjected to a drying treatment similar to that described above.

Silver ions are then carried on the carrier obtained in the manner described above. For example, an aqueous solution of a salt of an inorganic acid or organic acid of silver is prepared, the carrier is then immersed in the aqueous solution, and stirred, or a method in which a column is filled with the carrier, and the aqueous solution is made to flow into the column.

Examples of the salt of an inorganic acid or organic acid of silver include silver nitrate, silver sulfate, silver carbonate, silver chlorate, silver nitrite, silver perchlorate, silver sulfite, silver acetate, silver lactate, silver citrate and silver salicylate, and silver nitrate is preferred from the viewpoint of solubility in water.

(Method for Use of Iodine Adsorbing System and Iodine Adsorbent)

An adsorbing system using the above-described iodine adsorbent, and a method for use thereof will now be described. The iodine adsorbing system includes an adsorbent unit having an iodine adsorbent, a supplying unit supplying target medium water including iodide for the iodine adsorbent of the adsorbent unit, a discharging unit discharging the target medium water from the adsorbent unit, a measuring unit measuring concentration of an iodide in the target medium water provided in the supplying unit side, the discharging unit side, or both of the supplying unit side and the discharging unit side, and a controller controlling flow of the target medium water from the supplying unit to the adsorbent unit when a value calculated or obtained from a measured value in the measuring unit reaches set value.

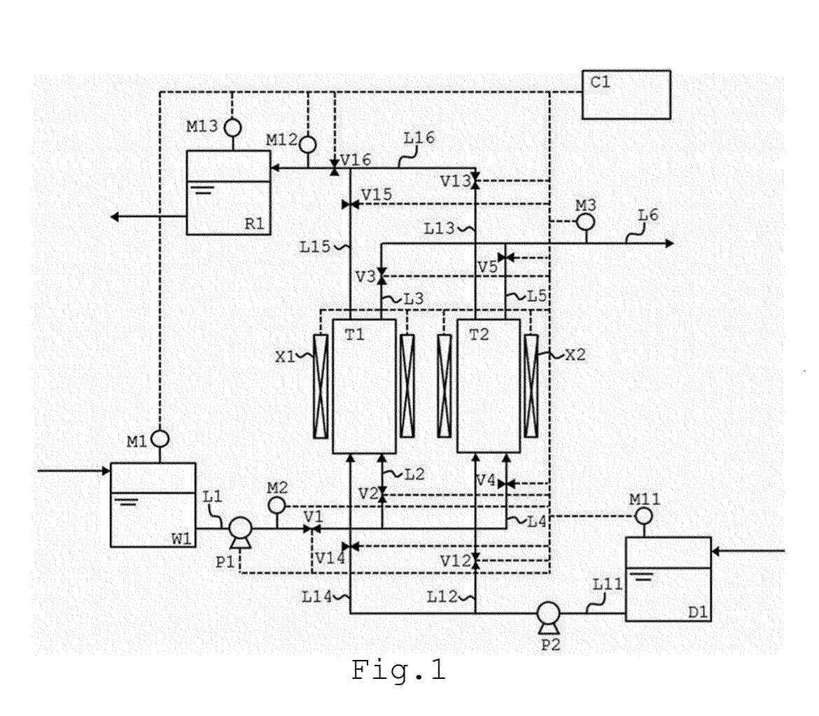

FIG. 1 is a conceptual view showing an outlined configuration of an apparatus used for adsorption of iodine in this embodiment, and a treating system.

As shown in FIG. 1, in this apparatus, water treating tanks (adsorbing units) T1 and T2 filled with the above-described iodine adsorbent are arranged side by side, and contact efficiency promoting units X1 and X2 are provided outside the water treating tanks T1 and T2. The contact efficiency promoting units X1 and X2 may be mechanical stirrers or non-contact magnetic stirrers, but are not essential components, and therefore may be omitted.

The water treating tanks T1 and T2 are connected through wastewater supplying lines (supplying units) L1, L2 and L4 to a wastewater storing tank W1 storing wastewater containing an iodine, and are connected to outside through wastewater discharging lines (discharging units) L3, L5 and L6.

The supplying lines L1, L2 and L4 are provided with valves (controlling units) V1, V2 and V4, respectively, and the discharging lines L3 and L5 are provided with valves V3 and V5. The supplying line L1 is provided with a pump P1. Further, the wastewater storing tank W1, the supplying line L1 and the discharging line L6 are provided with concentration measuring units (measuring units) M1, M2 and M3, respectively.

Control of the valves and pump and monitoring of measurements in the measurement apparatus are collectively centralized-managed by a controller C1.

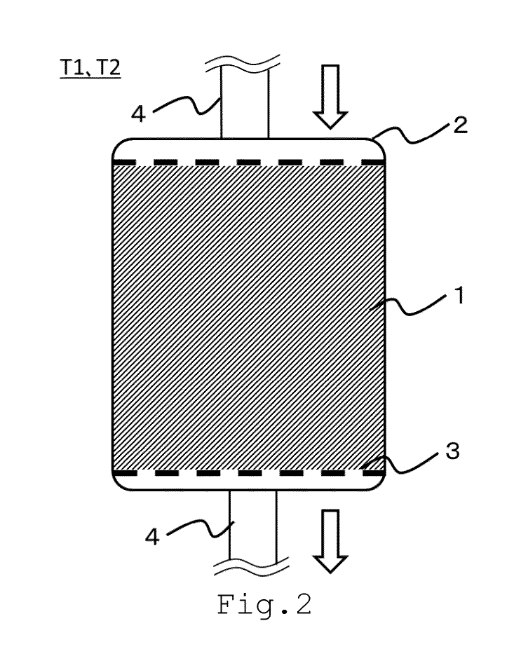

FIG. 2 shows a sectional schematic view of water treating tanks T1 and T2 connected to pipes 4 (L2 to L4) and filled with the iodine adsorbent. The arrow in FIG. 2 shows a direction in which target water flows. The water treating tanks T1 and T2 each include an iodine adsorbent 1; a tank 2 storing the iodine adsorbent; and a partition plate 3 for preventing the iodine adsorbent from being leaked to outside the tank 2. The water treating tanks T1 and T2 may be in a cartridge type form in which the tank 2 itself can be replaced, or may be in a form in which the iodine adsorbent in the tank 2 can be replaced. When there are substances to be adsorbed and collected, in addition to iodine, other adsorbents can be stored in the tank 2.

Iodine adsorption operations using the apparatus shown in FIG. 1 will now be described.

First, wastewater is supplied from the tank W1 through the wastewater supplying lines L1, L2 and L4 to the water treating tanks T1 and T2 by the pump P1. At this time, iodine in wastewater is adsorbed to the water treating tanks T1 and T2, and wastewater after adsorption of the halogen is discharged to outside through the wastewater discharging lines L3 and L5.

At this time, the contact efficiency promoting units X1 and X2 are driven as necessary to increase the contact area between the iodine adsorbent filling the water treating tanks T1 and T2 and wastewater, so that efficiency of adsorption of iodine by the water treating tanks T1 and T2 can be improved.

Here, the adsorption states of the water treating tanks T1 and T2 are observed using the concentration measuring unit M2 provided on the supplying unit side and the concentration measuring unit M3 provided on the discharging unit side of the water treating tanks T1 and T2. When adsorption is successfully performed, the concentration of iodine measured by the concentration measuring unit M3 shows a value lower than the concentration of iodine measured by the concentration measuring unit M2. However, a difference in the concentration of iodine between the concentration measuring units M2 and M3 arranged on the supplying unit side and the discharging unit side, respectively, decreases as adsorption of iodine in the water treating tanks T1 and T2 proceeds.

Therefore, when a predetermined value set beforehand by the concentration measuring unit M3 is reached, so that it is determined that the capability of adsorbing iodine by the water treating tanks T1 and T2 is saturated, the controller C1 temporarily stops the pump P1, and closes the valves V2, V3 and V4 to stop supply of wastewater to the water treating tanks T1 and T2 according to information from the concentration measuring units M2 and M3.

Although not illustrated in FIG. 1, pH of wastewater may be measured by the concentration measuring unit M1, the concentration measuring unit M2, or both the concentration measuring unit M1 and the concentration measuring unit M2, and adjusted through the controller C1 when pH of wastewater varies, or is that of strong acid or strong alkali and falls out of a pH range suitable for the adsorbent according to this embodiment.

After the water treating tanks T1 and T2 are saturated, they are appropriately replaced with water treating tanks filled with a new iodine adsorbent, and the water treating tanks T1 and T2 saturated for adsorption of iodine are appropriately subjected to a necessary post-treatment. For example, when the water treating tanks T1 and T2 contain radioactive iodine, for example, the water treating tanks T1 and T2 are crushed, then cemented, and stored in an underground facility etc. as radioactive wastes.

In the example described above, a system for adsorbing iodine in wastewater using a water treating tank and operations thereof have been described, but iodine in a waste gas can also be adsorbed and removed by causing an iodine-containing waste gas to pass through a column as described above.

The present disclosure will be described in detail below.

### Example 1

Silica gel (QARiACT-Q6 manufactured by FUJI SILYSIA CHEMICAL LTD.) was classified to particle sizes 300 to 500 μm by a sieving method, and the water content was adjusted to 30% by mass. 3-mercaptopropyltrimethoxysilane (833.34 g) and toluene (1680.05 g) were added in a separable flask (5 L), and sufficiently stirred to be homogenized. Thereto was added silica gel (500 g) prepared by the foregoing method, and a mixing blade was placed. The flask was placed in a mantle heater, and heating and stirring was started. Just after the start of reflux, heating and stirring was performed for 9 hours while the refluxed state of the solvent was maintained. The flask was cooled to room temperature, and silica gel and the solution were separated from each other by suction filtration. The obtained silica gel was washed with toluene in an amount equal to that of the solvent, and dried by air until the solid content reached 90 wt; or more, thereby obtaining organic group-containing silica gel particles.

The organic group-containing silica gel particles (580.00 g) obtained as described above, glucono-1,5-lactone (573.42 g) and methanol (9471.37 g) were added in a separable flask (5 L), and a stirring blade was placed. The flask was placed in a mantle heater, and heating and stirring was performed for 6 hours while the reaction system was kept at a temperature of 60° C. The flask was cooled to room temperature, and silica gel and the solution were separated from each other by suction filtration. The obtained silica gel was first washed with methanol in an amount equal to that of the reaction solvent, and then washed with pure water with a volume 1.5 times as large as that of the reaction solvent. The silica gel was dried by air until the solid content reached 90 wt % or more, thereby obtaining a reaction product.

Silver nitrate (365.29 g) was added in a polymer container (20 L), pure water (11811.11 g) was added thereto, and the mixture was sufficiently stirred to completely dissolve silver nitrate. Thereto was added the reaction product (690.00 g) obtained in 2-3-2, a mixing blade was placed, and the mixture was stirred at room temperature for 1 hour. The silica gel and the solution were separated from each other by suction filtration, and the obtained silica gel was washed with pure water until the filtrate became neutral. After being washed, the silica gel was returned to the polymer container, pure water (with a volume 20 times as large as that of the silica gel) was added, and the mixture was stirred for 1 hour. The silica gel and the solution were separated from each other by suction filtration, and the silica gel was washed with pure water (with a volume 25 times as large as that of the silica gel) to obtain the title compound.

### Example 2

An adsorbent of Example 2 was obtained in the same manner as in Example 1 except that after the silane coupling reaction, silica gel was dried by heating and drying at 130° C. rather than drying by air.

### Example 3

An adsorbent of Example 3 was obtained in the same manner as in Example 1 except that the water content of silica gel was 20% by mass.

### Example 4

An adsorbent of Example 4 was obtained in the same manner as in Example 1 except that the water content of silica gel was 20% by mass, and after the silane coupling reaction, silica gel was dried by heating and drying at 130° C. rather than drying by air.

### Example 5

An adsorbent of Example 5 was obtained in the same manner as in Example 1 except that Silica Gel 60N (particle size: 100 to 210 μm) manufactured by Kanto Chemical Co., Inc. was used as silica gel, and the water content of silica gel was 25% by mass.

### Comparative Example 1

An adsorbent of Comparative Example 1 was obtained in the same manner as in Example 1 except that the water content of silica gel was 5% by mass.

### Comparative Example 2

An adsorbent of Comparative Example 2 was obtained in the same manner as in Example 2 except that the water content of silica gel was 40% by mass.

### Comparative Example 3

An adsorbent of Comparative Example 3 was obtained in the same manner as in Example 1 except that Silica Gel 60N (particle size: 100 to 210 μm) manufactured by Kanto Chemical Co., Inc. was used as silica gel, and the water content of silica gel was 5% by mass.

An iodine adsorbing performance test in Examples 1 to 5 and Comparative Examples 1 to 3 will be described. The adsorbent (20 mg) obtained as described above and a test solution (10 ml) containing potassium iodide and sodium chloride each in a concentration of 500 mg/L were added in a plastic screw vial (10 ml), and the mixture was stirred at 60 rpm under room temperature for 1 hour using a horizontal-type mix rotor. Thereafter, the mixture was filtered using a cellulose membrane filter (Minisart RC-15) having a pore size of 0.2 μm, and an iodide ion concentration in the obtained aqueous solution was quantitatively determined.

The iodide ion concentration was calculated using ion chromatography. Alliance HPLC System manufactured by Nihon Waters K.K. was used as an ion chromatography device, and measurement was performed under the following conditions.

Column: Shodex IC SI-90 4E

Eluent: 1.8 nm Na₂CO₃+1.7 mm NaHCO₃ aq.

Flow rate: 1.2 mL/min

Detector: Shodex CD Suppressor module

Column temperature: 30° C.

As an index of the iodide ion adsorbing capability, an iodide ion adsorption amount per unit mass (hereinafter referred to as mg-I/g) was used.

A silica gel elution amount test in Examples 1 to 4 and Comparative Examples 1 to 3 will be described. The adsorbent (20 mg) obtained as described above and pure water (20 ml) were added in a plastic screw vial (10 ml), and the mixture was stirred at 60 rpm under room temperature for 1 hour using a horizontal-type mix rotor. Thereafter, the mixture was filtered using a cellulose membrane filter (Minisart RC-15) having a pore size of 0.2 μm, and a Si concentration in the obtained aqueous solution was quantitatively determined.

The Si concentration was calculated using ICP emission spectrophotometry. As a device, SPS-4000 manufactured by STI NanoTechnology Inc. was used.

The atomic ratio of sulfur to silicon (M_{S}/M_{Si}) was calculated by EDX analysis under the above-described conditions.

As an index of the silica gel elution amount, a Si elution amount per unit mass (hereinafter referred to as mg-Si/g) was used.

A value obtained by dividing the foregoing M_{S}/M_{Si} by a specific surface area A (m²/g) of the carrier was calculated for making comparison between materials having different particle sizes. For QARiACT-Q6, the specific surface area was calculated by the BET method using Micromeritics TriStar II3020 from Shimadzu Corporation. For Silica Gel 60N, values in the material data sheet issued by Kanto Chemical Co., Inc. were used.

A long-term water conduction test in Examples 1 to 2 and Comparative Example 1 will be described. MARINE ART (mix of artificial sea water manufactured by OSAKA YAKKEN Co., Ltd.) was diluted with ion-exchanged water to prepare 34% sea water. An adsorbent was added therein, and immersed under a reduced pressure to be degassed. A column having a diameter of 18 mm and a height of 80 cm was charged with 10 ml of the adsorbent degassed by the foregoing method. The 34% artificial sea water prepared by the foregoing method was made to pass through the column for 20 to 36 days at a circulation flow rate of SV10. The adsorbent was taken out from the column, and a particle size distribution was measured.

The measurement was performed under the following conditions: SALD-3100 manufactured by Shimadzu Corporation was used as a particle size distribution measurement device, ultrasonic irradiation was not conducted, and a value of 1.55 as described in the manual was used as a refractive index of silicon dioxide.

As an index of decrease in volume of the adsorbent, a decreasing rate of the median diameter of the absorbent after completion of water conduction with respect to the median diameter of the adsorbent before start of water conduction was used. SALD-3100 manufactured by Shimadzu Corporation was used as a median diameter (diameter) measurement device.

Particle size decreasing rate=100×(median diameter of adsorbent before water conduction−median diameter of adsorbent after water conduction)/(median diameter of adsorbent before water conduction).

Results of Evaluations of Various Kinds of Performance in Examples and Comparative Examples

TABLE 1

| | Initial | Drying | | Specific |
|---|---|---|---|---|
| | water | condition | | surface |
| | content of | after silane | | area of |
| | silica gel | coupling | Particle | silica gel |
| | (wt %) | reaction | size (μm) | (m²/g) |
| Example 1 | 30 | Room | 300-500 | 522 |
| | | temperature | | |
| Example 2 | 30 | Heating | 300-500 | 522 |
| Example 3 | 20 | Room | 300-500 | 522 |
| | | temperature | | |
| Example 4 | 20 | Heating | 300-500 | 522 |
| Example 5 | 25 | Room | 100-210 | 680 |
| | | temperature | | |
| Comparative | 5 | Room | 300-500 | 522 |
| Example 1 | | temperature | | |
| Comparative | 40 | Room | 300-500 | 522 |
| Example 2 | | temperature | | |
| Comparative | 5 | Room | 100-210 | 680 |
| Example 3 | | temperature | | |

Results of Evaluations of Various Kinds of Performance in Examples and Comparative Examples

TABLE 2A

| | | Iodine | |
|---|---|---|---|
| | Si elution | adsorption | |
| | amount | amount | S/Si element |
| | (mg-Si/g) | (mg-I/g) | ratio (g/m²) |
| Example 1 | 0.1 | 28 | 2.5E−04 |
| Example 2 | 0.103 | 26 | 2.7E−04 |
| Example 3 | 0.14 | 25 | 2.5E−04 |
| Example 4 | 0.07 | 26 | 2.7E−04 |
| Example 5 | 0.09 | 30 | 2.4E−04 |
| Comparative | 0.93 | 28 | 2.3E−04 |
| Example 1 | | | |
| Comparative | ND | 3 | 5.7E−04 |
| Example 2 | | | |
| Comparative | 1.4 | 53 | 2.2E−04 |
| Example 3 | | | |

TABLE 2B

| | Volume decreasing | Number of water |
|---|---|---|
| | rate in long-term | conduction days |
| | water (%) | (day) |
| Example 1 | 2.6-5.7 | 36 |
| Example 2 | 0.3-4.2 | 21 |
| Example 3 | — | — |
| Example 4 | — | — |
| Example 5 | — | — |
| Comparative | 13.5-16.7 | 20 |
| Example 1 | | |
| Comparative | — | — |
| Example 2 | | |
| Comparative | — | — |
| Example 3 | | |

As is evident from Table 1 and Table 2, the adsorbent obtained in each of examples has an iodine adsorbing capability, and has a lower Si elution amount as compared to comparative examples. The volume decreasing rate in the long-term water conduction test in Examples 1 and 2 is lower as compared to Comparative Example 1. From the above results, it is considered that an adsorbent having a low Si elution amount is considered to have a low volume decreasing rate in long-term water conduction, and therefore it is considered that in Examples 3 and 4, the volume decreasing rate in long-term water conduction is low similarly to Examples 1 and 2.

A test of dependency of iodine adsorbing performance on time in Examples 1 to 4 will be described. The adsorbent (50 mg) obtained as described above and a test solution (500 ml) containing potassium iodide and sodium chloride in a concentration of 50 mg/L and 17.6 mg/L, respectively, were added in a plastic screw bottle (500 ml), and the mixture was stirred at 25° C. and 60 rpm for 24 hours using a thermostatic shaking bath. In the meantime, 3 ml of supernatant was separated and taken each of 1 hour, 3 hours, 6 hours, 9 hours and 24 hours after the adsorbent was added to the test solution, the supernatant was filtered using a cellulose membrane filter (Minisart RC-15) having a pore size of 0.2 μm, and an iodide ion concentration in the obtained aqueous solution was quantitatively determined.

The iodide ion concentration was calculated using ion chromatography. Alliance HPLC System manufactured by Nihon Waters K.K. was used as an ion chromatography device, and measurement was performed under the following conditions.

Column: Shodex IC SI-90 4E

Eluent: 1.8 mm Na₂CO₃+1.7 mm NaHCO₃ aq.

Flow rate: 1.2 mL/min

Detector: Shodex CD Suppressor module

Column temperature: 30° C.

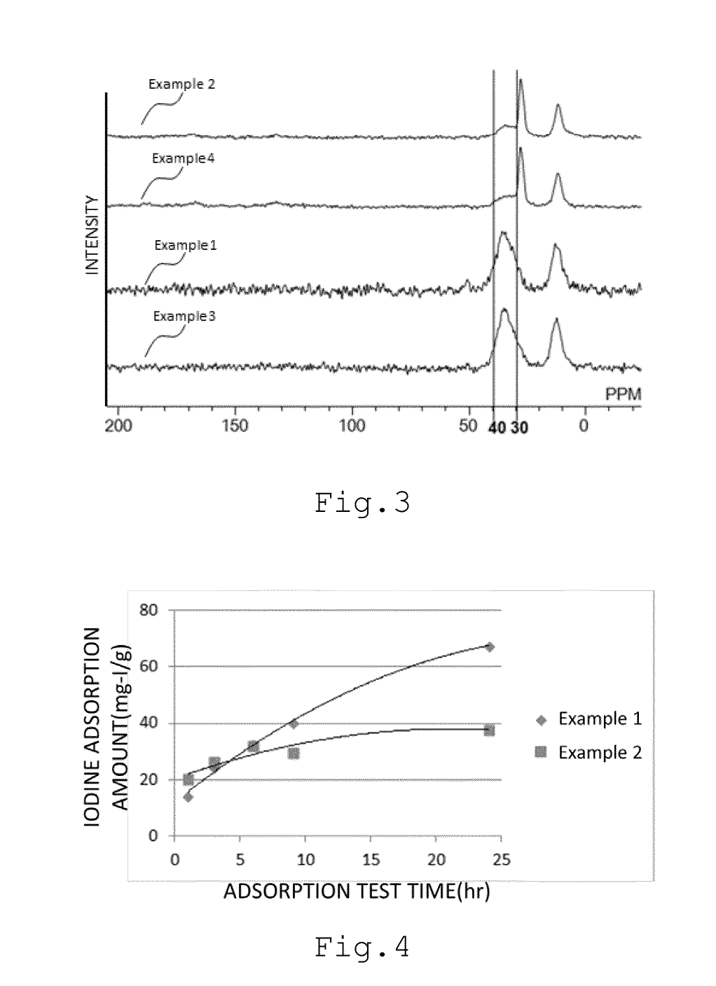

Measurement of the solid 13C NMR spectrum shown in FIG. 3 will be described. The solid 13C NMR spectrum in each of Examples 1 to 4 was measured under the following conditions using JNM-ECX 400/SH 40T6/VT (solid probe) manufactured by JEOL Ltd.

Observation nucleus: ¹³C (100.5 MHz)

Reference substance: TMS (external standard/0 ppm)

Measurement mode: CPMAS (Cross Polarization-Magic Angle Spinning) method

Sample tube rotation number: about 5 kHz

Contact time: 3 ms

Pulse delay time: 1 s

Results of evaluations of dependency of iodine adsorbing capability on time and results of measurement of solid 13C NMR spectrum in Examples 1 to 4.

TABLE 3A

| | Initial water | Drying condition |
|---|---|---|
| | content of silica | after silane coupling |
| | gel (wt %) | reaction |
| Example 1 | 30 | Room temperature |
| Example 2 | 30 | Heating |
| Example 3 | 20 | Room temperature |
| Example 4 | 20 | Heating |

TABLE 3B

| | Iodine | Iodine | |
|---|---|---|---|
| | adsorption | adsorption | Presence/absence |
| | amount for | amount for | of peak in |
| | 1 hour (mg-I/g) | 24 hour (mg-I/g) | range of 30 to 40 ppm |
| Example 1 | 14 | 68 | Present |
| | | | (35.8 ppm) |
| Example 2 | 20 | 38 | Absent |
| Example 3 | 37 | 56 | Present |
| | | | (35.0 ppm) |
| Example 4 | 37 | 49 | Absent |

The solid 13C-NMRspectra are shown in FIG. 3. The phrase “with tetramethylsilane as a reference” means that “the resonance frequency of tetramethylsilane is set to zero (0 ppm)”. A chemical shift can be determined in accordance with the following equation:

chemical shift δ(ppm)=(frequency difference from TMS/resonance frequency)×10⁶.

For example, when the resonance frequency is 300 MHz, the chemical shift of a peak at which the frequency difference from TMS is 300 Hz is 1.

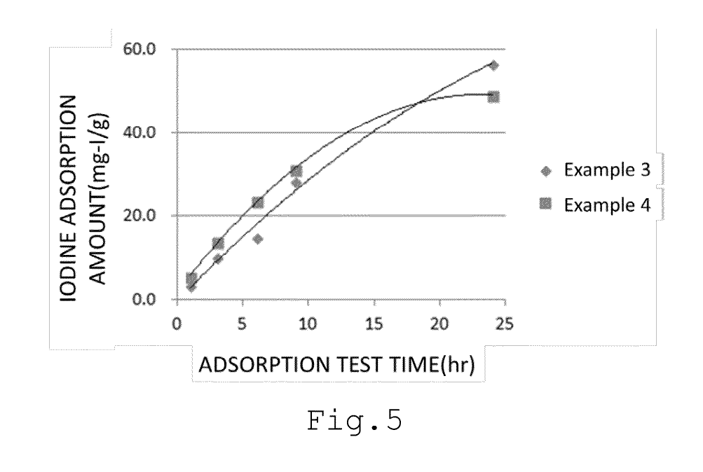

As is evident from Table 3, an among examples, Examples 1 and 3 having a peak in a range between 30 ppm and 40 ppm (30 ppm≦δ≦40 ppm) in the solid 13C NMR spectrum have a lower iodine adsorption amount at 24 hours as compared to Examples 2 and 4 having no peak in a range between 30 ppm and 40 ppm. As is evident from the graph of dependency of the iodine adsorption amount on time as shown in FIGS. 4 and 5, Examples 1 and 3 having a peak in a range between 30 ppm and 40 ppm have a more linear change in iodine adsorption amount to adsorption test time as compared to Examples 2 and 4 having no peak in a range between 30 ppm and 40 ppm. From the results described above, it can be said that the iodine adsorption amount can be retained for a long period of time particularly in Examples 1 and 3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An iodine adsorbent comprising:
a carrier that is a compound containing silicon;
an organic group bonded to the carrier; and
silver,
wherein the organic group has, at the terminal, a functional group represented by S⁻ or SR,
the silver is bonded to sulfur in S⁻ or SR,
the R is a hydrogen atom or a substituent containing a hydrocarbon, and
where the element ratio of sulfur in the adsorbent to silicon in the adsorbent is M_{S}/M_{Si}, M_{S}/(M_{Si}·A), a value obtained by dividing the element ratio by a specific surface area A (m²/g) of the carrier, is 2.4×10⁻⁴ g/m²≦M_{S}/(M_{Si}·A)≦2.7×10⁻⁴ g/m².

2. The adsorbent according to claim 1, wherein
the carrier and the functional group are coupled to each other by an alkyl group, and
the iodine adsorbent has a peak in a range of 30 ppm≦δ≦40 ppm in terms of a chemical shift δ with tetramethylsilane as a reference in solid 13C-NMR spectrum measurement of the alkyl group.

3. The adsorbent according to claim 1, wherein the functional group represented by SR is a functional group selected from a thiol group, a sulfide group and a thioester polyol group.

4. The adsorbent according to claim 1, wherein the carrier is silica gel.

5. A water treatment tank storing an iodine adsorbent, wherein the iodine adsorbent comprising:
a carrier that is a compound containing silicon;
an organic group bonded to the carrier; and
silver,
wherein the organic group has, at the terminal, a functional group represented by S⁻ or SR,
the silver is bonded to sulfur in S⁻ or SR,
the R is a hydrogen atom or a substituent containing a hydrocarbon, and
where the element ratio of sulfur in the adsorbent to silicon in the adsorbent is M_{S}/M_{Si}, M_{S}/(M_{Si}·A), a value obtained by dividing the element ratio by a specific surface area A m²/g) of the carrier, is 2.4×10⁻⁴ g/m²≦M_{S}/(M_{Si}·A)≦2.7×10⁻⁴ g/m².

6. The tank according to claim 5, wherein
the carrier and the functional group are coupled to each other by an alkyl group, and
the iodine adsorbent has a peak in a range of 30 ppm≦δ≦40 ppm in terms of a chemical shift δ with tetramethylsilane as a reference in solid 13C-NMR spectrum measurement of the alkyl group.

7. The tank according to claim 5, wherein the functional group represented by SR is a functional group selected from a thiol group, a sulfide group and a thioester polyol group.

8. The tank according to claim 5, wherein the carrier is silica gel.

9. An iodine adsorbing system comprising:
an adsorbent unit having an iodine adsorbent;
a supplying unit supplying target medium water including iodide, to the adsorbent unit;
a discharging unit discharging the target medium water from the adsorbent unit;
a measuring unit measuring concentration of an iodide in the target medium water provided in a supplying unit side, a discharging unit side, or both of the supplying unit side and the discharging unit side; and
a controller controlling flow of the target medium water from the supplying unit to the adsorbent unit when a value calculated or obtained from a measured value in the measuring unit reaches set value,
wherein the iodine adsorbent comprising:
a carrier that is a compound containing silicon;
an organic group bonded to the carrier; and
silver,
wherein the organic group has, at the terminal, a functional group represented by S⁻ or SR,
the silver is bonded to sulfur in S⁻ or SR,
the R is a hydrogen atom or a substituent containing a hydrocarbon, and
where the element ratio of sulfur in the adsorbent to silicon in the adsorbent is M_{S}/M_{Si}, M_{S}/M_{Si}·A), a value obtained by dividing the element ratio by a specific surface area A (m²/g) of the carrier, is 2.4×10⁻⁴ g/m²≦M_{S}/(M_{Si}·A)≦2.7×10⁻⁴ g/m².

10. The system according to claim 9, wherein
the carrier and the functional group are coupled to each other by an alkyl group, and
the iodine adsorbent has a peak in a range of 30 ppm≦δ≦40 ppm in terms of a chemical shift δ with tetramethylsilane as a reference in solid 13C-NMR spectrum measurement of the alkyl group.

11. The system according to claim 9, wherein the functional group represented by SR is a functional group selected from a thiol group, a sulfide group and a thioester polyol group.

12. The system according to claim 9, wherein the carrier is silica gel.
